(19) United States
(12) Patent Application Publication
(10) Pub. No.: US 2007/0143060 A1
(43) Pub. Date: Jun. 21, 2007

(54) Temperature monitoring system

(75) Inventor: Chien-Sheng Chiu, Taichung (TW)

Correspondence Address: DARBY & DARBY P.C., P. O. BOX 5257, NEW YORK, NY, 10150-5257, US

(73) Assignee: Syris Technology Corp., Taichung (TW)

(21) Appl. No.: 11/453,762

(22) Filed: Jun. 14, 2006

(30) Foreign Application Priority Data
Dec. 6, 2005 (TW) 094142940

(51) Int. Cl. G01K 13/00

(52) U.S. Cl. 702/131

(57) ABSTRACT

A temperature monitoring system includes first and second sensors, a microcontroller, a transmission unit, and a remote monitoring unit. The first sensor measures a skin temperature of a patient. The second sensor measures an ambient temperature of the patient. The microcontroller generates an actual temperature value with reference to the temperatures measured by the first and second sensors, and generates a warning signal when the actual temperature value generated thereby is within a predetermined temperature range. The transmission unit transmits the actual temperature value and the warning signal. The remote monitoring unit receives the actual temperature value and the warning signal, and records the time the warning signal was received thereby and location of the transmission unit.

### BACKGROUND OF THE INVENTION

1. Field of the Invention

The invention relates to a temperature monitoring system, more particularly to a temperature monitoring system that is capable of monitoring a body temperature of a patient from afar.

2. Description of the Related Art

Infrared ear thermometers are widely used for measuring a body temperature of a patient. During use, a short tube, with a protective sleeve, is inserted into the ear of the patient, and a button is pressed to actuate an infrared detector. Thereafter, the infrared ear thermometer beeps, and a readout of the body temperature of the patient is produced on a liquid crystal display.

Although the known infrared ear thermometer achieves its intended purpose, since the body temperature of the patient has to be routinely monitored, the use of the known infrared ear thermometer causes inconvenience on the part of a caregiver. To solve this problem, it has been proposed to use a battery-operated thermometer that is attached securely to the patient and that automatically measures a skin temperature of the patient. This, however, can cause other problems. Particularly, since ambient temperature can easily affect the skin temperature of the patient, the proposed thermometer may obtain an inaccurate result.

### SUMMARY OF THE INVENTION

Therefore, the object of the present invention is to provide a temperature monitoring system that can overcome the aforesaid drawbacks of the prior art.

According to the present invention, a temperature monitoring system comprises first and second sensors, a microcontroller, a transmission unit, and a remote monitoring unit. The first sensor is adapted to measure a skin temperature of a patient. The second sensor is adapted to measure an ambient temperature of the patient. The microcontroller is coupled to the first and second sensors, and is operable so as to generate an actual temperature value with reference to the temperatures measured by the first and second sensors and so as to generate a warning signal when the actual temperature value generated thereby is within a predetermined temperature range. The transmission unit is coupled to and is controlled by the microcontroller to transmit at least one of the actual temperature value and the warning signal generated by the microcontroller. The remote monitoring unit is operable so as to receive said at least one of the actual temperature value and the warning signal transmitted by the transmission unit, and so as to record the time the warning signal was received thereby and location of the transmission unit which transmitted the warning signal.

### BRIEF DESCRIPTION OF THE DRAWING

Other features and advantages of the present invention will become apparent in the following detailed description of the preferred embodiment with reference to the accompanying drawing, of which:

FIG. 1 is a schematic circuit block diagram of the preferred embodiment of a temperature monitoring system according to the present invention.

### DETAILED DESCRIPTION OF THE PREFERRED EMBODIMENT

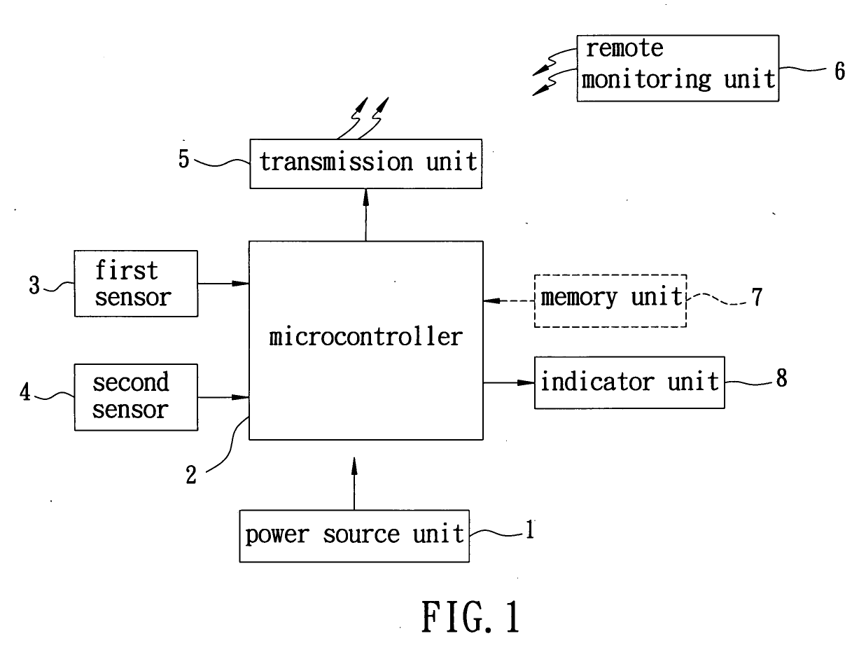

Referring to FIG. 1, the preferred embodiment of a temperature monitoring system according to this invention is shown to include first and second sensors 3, 4, a microcontroller 2, a transmission unit 5, and a remote monitoring unit 6.

The temperature monitoring system of this embodiment is applicable for monitoring a body temperature of a patient (not shown), in a manner that will be described hereinafter.

The first sensor 3 measures a skin temperature of the patient. In this embodiment, the first sensor 3 is a temperature sensor implemented in an integrated circuit.

The second sensor 4 measures an ambient temperature of the patient. In this embodiment, the second sensor 4, like the first sensor 3, is a temperature sensor implemented in an integrated circuit.

The temperature monitoring system further includes a memory unit 7 that is coupled to the microcontroller 2 for storing object data and first and second sets of temperature correcting factors therein. In this embodiment, the memory unit 7 is an EEPROM that is built-in to the microcontroller 2. In an alternative embodiment, the memory unit 7 is an external hard disk drive that is coupled removably to the microcontroller 2 via a universal serial bus (USB).

It is noted that each of the temperature correcting factors in the first set corresponds to the temperature measured by the second sensor. That is, for ambient temperatures 22° C., 22° C. to 27° C., 28° C., 32° C., and 35° C., the temperature correcting factors are +0.3° C., 0° C., −0.3° C., −0.4° C., and −0.5° C., respectively. Moreover, the object data is pertinent to the patient whose temperature is to be monitored, such as name, age, telephone number, address, etc. Further, each of the temperature correcting factors in the second set corresponds to an age group of a specific patient. That is, for patients in the age group of 1 to 19 years, 20 to 50 years, and above 50 years, the temperature correcting factor is −0.2° C., 0° C., and +0.2° C., respectively.

The microcontroller 2 is coupled to the first and second sensors 3, 4, and is operable so as to routinely generate an actual temperature value with reference to the temperatures measured by the first and second sensors 3, 4, and the temperature correcting factors in the first and second sets. In particular, the microcontroller 2 adds the temperature correcting factor in the first set, which corresponds to the ambient temperature measured by the second sensor 4, and the temperature correcting factor in the second set, which corresponds to the age group of the patient, to the skin temperature measured by the first sensor 3, so as to result in the actual temperature value. As such, the actual temperature values routinely generated by the microcontroller 2 are an accurate indication of the body temperature of the patient.

The microcontroller 2 is further operable so as to generate a warning signal when the actual temperature value generated thereby is within a predetermined temperature range. It is noted that the predetermined temperature range is above a normal temperature range of a person. As such, when the microcontroller 2 generates the warning signal, it suggests that the patient has a fever.

The temperature monitoring system further includes an indicator unit 8 for notifying a caregiver that the patient has a fever. In particular, the indicator unit 8 is coupled to and is controlled by the microcontroller 2 to provide an indication when the microcontroller 2 generates the warning signal. In this embodiment, the indicator unit 8 includes a light-emitting device, preferably a light-emitting diode, which provides the indication by emitting a flashing light, and a sound-generating device, preferably a buzzer, which provides the indication by generating an audible sound.

The transmission unit 5 is coupled to and is controlled by the microcontroller 2 to wirelessly transmit the actual temperature values and the warning signal generated by the microcontroller 2. In this embodiment, the transmission unit 5 includes a radio frequency transceiver. In an alternative embodiment, the transmission unit 5 may include a Bluetooth-compliant transceiver.

The remote monitoring unit 6 is operable so as to receive the actual temperature values and the warning signal transmitted by the transmission unit 5, thereby permitting monitoring of changes in the body temperature of the patient and immediate notification that the patient is having a fever from afar, so as to record the time the warning signal was received thereby and location of the transmission unit 5 which transmitted the warning signal, and so as to store (or update) the object data and the first and second sets of the temperature correcting factors into the memory unit 7 through the transmission unit 5.

The temperature monitoring system further includes a power source unit 1 for providing electrical power to the first and second sensors 3, 4, the microcontroller 2, the indicator unit 8, and the transmission unit 5. In this embodiment, the power source unit 1 includes a pair of battery cells.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A temperature monitoring system, comprising:
a first sensor adapted to measure a skin temperature of a patient;
a second sensor adapted to measure an ambient temperature of the patient;
a microcontroller coupled to said first and second sensors, and operable so as to generate an actual temperature value with reference to the temperatures measured by said first and second sensors and so as to generate a warning signal when the actual temperature value generated thereby is within a predetermined temperature range;
a transmission unit coupled to and controlled by said microcontroller to transmit at least one of the actual temperature value and the warning signal generated by said microcontroller; and
a remote monitoring unit operable so as to receive said at least one of the actual temperature value and the warning signal transmitted by said transmission unit, and so as to record the time the warning signal was received thereby and location of said transmission unit which transmitted the warning signal.

2. The temperature monitoring system as claimed in claim 1, further comprising a memory unit coupled to said microcontroller for storing object data pertinent to the patient whose temperature is to be monitored.

3. The temperature monitoring system as claimed in claim 2, wherein said memory unit is built-in to said microcontroller.

4. The temperature monitoring system as claimed in claim 2, wherein said memory unit is coupled removably to said microcontroller.

5. The temperature monitoring system as claimed in claim 2, wherein said remote monitoring unit is further operable so as to store the object data into said memory unit through said transmission unit.

6. The temperature monitoring system as claimed in claim 1, wherein said microcontroller further stores a temperature correcting factor therein, and generates the actual temperature value with reference to the temperatures measured by said first and second sensors and the temperature correcting factor.

7. The temperature monitoring system as claimed in claim 1, further comprising an indicator unit coupled to and controlled by said microcontroller so as to provide an indication when said microcontroller generates the warning signal.

8. The temperature monitoring system as claimed in claim 7, wherein said indicator unit includes at least one of a light-emitting device and a sound-generating device.

9. The temperature monitoring system as claimed in claim 1, wherein at least one of said first and second sensors is a temperature sensor implemented in an integrated circuit.

10. The temperature monitoring system as claimed in claim 1, wherein said transmission unit includes a radio frequency transceiver.

11. The temperature monitoring system as claimed in claim 1, wherein said transmission unit includes a bluetooth-compliant transceiver.
